(19) United States
(12) Patent Application Publication
(10) Pub. No.: US 2010/0173213 A1
(43) Pub. Date: Jul. 8, 2010

(54) ADVANCED SOLID OXIDE FUEL CELL STACK DESIGN FOR POWER GENERATION

(75) Inventors: Frederick F. Lange, Santa Barbara, CA (US); Anil V. Virkar, Salt Lake CIty, UT (US)

Correspondence Address: PETERS VERNY , L.L.P., 425 SHERMAN AVENUE, SUITE 230, PALO ALTO, CA, 94306, US

(73) Assignee: The Regents of the University of California, Oakland, CA (US)

(21) Appl. No.: 11/993,649

(22) PCT Filed: Jun. 30, 2006
(86) PCT No.: PCT/US06/25871

§ 371 Date: Dec. 3, 2009

Related U.S. Application Data
(60) Provisional application No. 60/696,036, filed on Jul. 1, 2005.

(51) Int. Cl. H01M 8/04; H01M 8/24

(52) U.S. Cl. 429/436; 429/466

(57) ABSTRACT

The present invention concerns improved configurations for a fuel cell army. The contacts for the positive electrode and the negative electrode are made outside the higher temperature active reaction space in a cooler area. Thus different more common materials are used which have a longer lifetime and have less stresses at their lower operating temperature. The invention utilizes tubular cell components connected with spines for efficient electron transfer and at least two manifolds outside the reaction zone, which may be cooled by external means. The external protruding connectors are thus at a lower operating temperature. This invention improves fuel cell life span, provides for lower cost, use of more common materials, and reduces the number thermal defects during operation.

### CROSS-REFERENCE TO RELATED APPLICATIONS

### BACKGROUND OF THE INVENTION

1. Field of the Invention

The present invention relates to a solid oxide fuel cell (SOFC) stack as disclosed herein that the stacking arrangement allows the cell to cell (or bundle to bundle) electrical connections to be made outside of the active hot-zone. The connections are cooled, and the materials may be selected from more common metals. Other attributes also exist for this new design. These include the reduction of residual stresses within the stack during operation due to the fuel cell symmetry, and the symmetry of the periodic arrangement of the cells.

The new design of the stacking of solid-oxide fuel cells (SOFC), with either a circular, or elliptical cross-section as a bundle of hexagonal or triangular cross section is disclosed. For state of the art stack designs, the electrical connections between the individual cells must be located within the active hot zone of the cell stack. Therefore, these connections must be made of materials that are also stable in both oxidizing and reducing environments present. The current state of the art severely limits the economics and reliability of current stack designs. For example, the asymmetry of the three components and asymmetry of stresses lead to stress concentrations in the Westinghouse design. Also there is a lack of shape retention during cooling and heating in the planar stack design.

2. Description of Related Art

“Fuel cells are an important technology for a potentially wide variety of applications including micropower, auxiliary power, transportation power, stationary power for buildings and other distributed generation applications, and central power. These applications will be in a large number of industries worldwide” (as quoted from Dr. Mark C. Williams, Strategic Center for Natural Gas, National Energy Technology Laboratory, Fuel Cell Handbook, 6^{th} Edition, DOE/NETL-2002/1179, 2003).

Fuel cells are electrochemical devices that convert the chemical energy of a reaction directly into electrical energy. One very important type of fuel cell is based on an oxide electrolyte. It is called a Solid Oxide Fuel Cell (SOFC).

The basic physical structure, or building block, of a SOFC consists of a dense electrolyte layer that conducts oxygen ions in contact with a porous anode and a porous cathode on either side. The cathode is exposed to the gas containing oxygen (e.g., air or oxygen). It converts the oxygen molecules into oxygen ions and produces 4 electrons per oxygen molecule to the two ions created by the conversion. The negatively charged oxygen ions rapidly diffuse through the electrolyte, chemically driven to react with the fuel on the anode side of the cell, where they release the 4 electrons (per oxygen molecule). In some configurations, an SOFC uses a high temperature proton-conducting ceramic as an electrolyte. In such cases, protons transport from the anode, through the electrolyte, to the cathode. The electrolyte must be heated to a high temperature between about 600° C. to 1000° C. (depending on the electrolyte material) to achieve sufficient oxygen ion conductivity. This process generates voltage and/or an electrical current, depending upon the load. Voltage is generated when the two electrodes are not connected to one another, whereas current is generated when the two electrodes are connected, usually through a useful device such as a motor, light bulb, etc. Heat is generated by the reaction, and this heat is used to sustain the temperature needed to operate the SOFC. Excess heat is used to drive auxiliary devices (home heating, etc., etc.) When both the heat of the reaction and electrical energy are accounted for, the efficiency of this process can be as high as 80%. Thus, the SOFC is one of the most efficient devices to generate energy. When hydrogen is the fuel, the reaction product is simply clean, pure water, H₂O. Thus, this SOFC has the potential to generate energy at a low cost and without polluting the environment.

In order to form a useful SOFC system, the basic building blocks are connected together to form a device that contains multiple cells, generally known as a stack. That is, the basic unit, cathode-electrolyte-anode must be connected to another, either in a series arrangement or a parallel arrangement, in the same manner that batteries are joined together either in series to produce a higher voltage (a multiple of the single battery voltage), or in parallel, to produce the same voltage as the single cell, but a larger current. Namely, the individual solid oxide fuel cells must be connected together to form a stack of cells.

As detailed below, the individual cells of the art are conventionally stacked with one of two different arrangements. In both systems, the electrical connections between the cells must be made in locations where much of the heat is generated, that is, the connections within the stack are made in a high temperature region. The need in current stacks for high temperature connections requires that the connecting material be stable at high temperatures, and stable in both oxidizing (cathode side) and reducing (anode side) environments. These special high temperature material requirements severely limit the operational efficiency and reliability of current stack designs.

On the other hand, as shown below, the new SOFC stack design as disclosed in this invention does not have these limitations. Instead, because of the unique design of each novel cell, and the unique method of stacking cells next to one another, the connection between the adjacent cells is made with air (or water) cooled metal connectors. This novel SOFC stack design also has other advantages relative to current designs that are provided in more detail below.

### SOFC Components and Materials

SOFC major components include the anode, the cathode, and the electrolyte. Fuel cell stacks contain an electrical interconnect that links adjacent cells together in series. SOFC components must meet certain general requirements in order to be useful. Electrolytes, electrodes and interconnects must be chemically, morphologically, and dimensionally stable in oxidizing and/or reducing environments. The component material must be chemically stable in order to limit chemical interactions and degradation with other cell materials. They must have similar thermal expansion coefficients in order to minimize thermal stresses that could cause cracking and delaminating during thermal cycling. It is also desirable that fuel cell components have high strength and durability, are easy to fabricate, and are relatively inexpensive.

Materials that rapidly conduct oxygen ions (O⁻²) can be used as solid electrolyte. The most commonly used electrolyte material for SOFCs is zirconium oxide (ZrO₂), where a fraction of the zirconium ions (Zr⁺⁴) is substituted with yttrium ions (Y⁺³). This electrolyte material is generally known as yttrium oxide (or yttria) stabilized zirconium oxide (or zirconia) (YSZ). YSZ is a preferred electrolyte material for SOFCs because it exhibits predominantly ionic (oxygen) conductivity over a wide range of oxygen partial pressures. The conductivity of oxygen ions is provided by the oxygen vacancies ( [symbol] ) that are introduced when Y⁺³ substitutes for Zr⁺⁴ into the Zr(Y)O₂ crystalline structure represented by the chemical formula, Zr₍₁₋ₓ₎YₓO_{(2-x/2)} [symbol] _{x/2}, were x is the atomic fraction of Y substituted for Zr.

Lanthanum strontium manganite, (La,Sr)MnO₃, (LSM), which has the perovskite structure, has been the most frequently used material for the cathode in SOFCs. Its thermal expansion coefficient matches well with zirconia electrolytes and provides good performance at temperatures above 800° C. The incorporation of up to 40 volume % or more of the electrolyte material (YSZ) into the cathode materials has been shown to improve electrode performance at lower temperatures by increasing the number of active sites available for electrochemical reactions.

Anode materials for SOFCs are commonly fabricated from composite powder mixtures of electrolyte materials, YSZ and nickel oxide. The nickel oxide is subsequently reduced to nickel metal prior to operation of the SOFC. The NiO/YSZ anode material is suited for applications with YSZ electrolytes. Typical anode materials have nickel contents of approximately 40 volume % after reduction of the nickel oxide to nickel.

State-of-the-Art SOFC Stack Designs—This section reviews the state-of-the-art of the two different SOFC stack designs, namely the tubular Siemens-Westinghouse SOFC stack and planar SOFC stack, commonly know as PSOFCs.

Tubular SOFC Stacks—FIGS. 1A and 1B illustrate a single cell 10 & 11 of the Siemens-Westinghouse tubular design of the conventional art, and FIGS. 2A and 2B illustrate how the cells 20 & 21 are stacked together. Each tube 10 shown in FIG. 1A is formed with the following sequence. A thick, strong supporting tube is first made of the cathode material (LSM) by extruding LSM powder mixed with a plastic binder followed by sintering. The cathode tube is fabricated with a porosity of 30 to 40% to permit rapid transport of the incoming oxidant gas (O₂+N₂) and depleted oxidant gas to and away from the cathode/electrolyte interface where the electrochemical reactions occur. The YSZ electrolyte is applied to the cathode tubes by electrochemical vapor deposition (EVD) method, which for many years has been the heart of Westinghouse (now Siemens-Westinghouse) technology. Recently, Siemens-Westinghouse switched over to a new process, termed atmospheric plasma spray deposition instead of the EVD process. The NiO/YSZ (or zirconia stabilized by some other oxide) mixed anode material is subsequently formed on the electrolyte by a slurry deposition method followed by sintering, and then by the reduction of the NiO to Ni, to form the porous Ni/ZrO₂ anode. The support tube is closed at one end, which eliminates the need for gas seals when the cells are connected together.

FIG. 1A shows that both the YSZ electrolyte 4 and the Ni/ZrO₂ anode 6 do not fully circumscribe the external surface of the tube 2, but instead, are arranged to produce a region that is exposed to the cathode tube. As shown in FIG. 1A, this exposed region is filled with an ‘interconnect’ material 8, generally a dense, lanthanum chromite (LaCrO₃), which as a material is stable in both an oxidizing and a reducing environment. When the tubes are stacked together (see FIG. 2A) the interconnect material 8 connects the cathode of one cell to the anode of an adjacent cell.

Air 25 (and thus oxygen) is introduced into the interior of each tube 2, and fuel gas 27 flows past the anode 6 on the exterior of each cell. FIG. 2B shows a bundle of eighteen cells that features 3 cells in series with 6 cells in parallel. Also shown is the nickel felt 9 that is used to make electrical connections within the hot zone 29 of the stack. That is, the nickel felt connects the interconnect region to the anode of adjacent cells and also connects the anode of a cell to the anode of an adjacent cell. It also connected the cathode bus 22 and the anode bus 26 to the stack.

Alternative Tubular Design—Alternative tubular designs are pursued by many developers, such as Acumentrics (see http://www.acumentrics.com/). These are anode-supported cells with a thin, dense electrolyte layer on the outer surface, upon which is deposited porous cathode. Usually, silver paint is applied on the cathode surface, and a silver wire is wound on the silver paint, to minimize sheet resistance and facilitate current collection. The cost and evaporation of silver are significant challenges, which limit the utility of this design to niche applications.

Planar SOFC Stacks (PSOFC)—In the planar configuration, the anode, electrolyte, and cathode form thin, flat layers that are sintered together. The plates can be either rectangular, square, circular, or segmented in series and can be manifolded for air and fuel flow either externally or internally.

Currently available PSOFC designs are categorized on the basis of the supporting component. The two approaches are either electrolyte supported, or anode supported; the anode supported design of a single planar cell is shown in FIG. 3 (e.g., 3A & 3B). The electrolyte 34 and interconnect layers are made by tape casting. The electrodes are applied by the slurry method, by screen-printing, or by plasma spraying.

In order to produce significant amounts of power, PSOFC elements are assembled into a stack analogous to a multi-layered sandwich. Individual cell assemblies, each including an anode 36, electrolyte 34, and cathode 32 are stacked with metal interconnecting plates between them. The metal plates 33, known as bipolar plates, are shaped to permit the flow of fuel and air to the membranes. The bipolar plate is essential for the so-called “stacking” of planar fuel cells; it not only connects the anode of one cell to the cathode of the next, but also separates the flow of air along the surface of the cathode, and the flow of fuel along the surface of the anode. One material candidate for the bipolar plate is ferritic stainless steel. However, a significant issue with this material is evaporation of a chromium hydrous oxide into the electrodes—degrading their performance. In addition, virtually all nickel-chromium-iron-based alloys undergo oxidation in both cathodic and anodic environments, with the oxide scale being usually a poor conductor of electricity. This added resistance, which increases with time of operation, lowers the overall power and efficiency.

To properly manifold the flow of air and fuel, the cell, including the bipolar plates, must be stacked sealed to one another. The requirements for stack seal materials are extremely stringent. Chemical compatibility of the seal material with the stack components and gaseous constituents of the highly oxidizing and reducing environments is also of primary concern. In addition, the seal should be electrically insulating to prevent shorting within the stack. Glass and glass-ceramic materials are the principal seal materials. The two issues of concern are the brittle nature of glass ceramics, and glasses tend to react with other cell components, such as electrodes, at SOFC operating temperatures. An alternative to glass is the use of mechanical, compressive, non-bonding seals. This approach permits the individual stack components to freely expand and contract during thermal cycling. However, the use, such as, of compressive seals also brings several new challenges to SOFC stack design; a load frame must be included to maintain the desired level of compressive load during operation. Also sealing efficiency is generally less than desired.

FIG. 4 is a photograph of a conventional PSOFC stack 40. One major technical difficulty with these structures is the generation of non-symmetric stresses in each cell. That is, because the materials within each cell have different thermal expansion coefficients, each cell, if initially flat, will try to curl when either heated or cooled. Curling of one cell will be constrained by the adjacent cell. Stresses will develop due to this constraint.

### Specific Description of Related Art

Some related patents and articles of interest include:

1) K. Kendell et al. in U.S. Pat. No. 6,696,187 assigned to Acumentrics Corporation discloses a fuel cell power generating system;

2) H. Misaira in U.S. Pat. No. 5,336,569 assigned to NGK Insulators, Ltd. Discloses multiple stacked fuel cell power generating equipment;

3) R. S. Bourgeois et al. in U.S. Pat. No. 6,844,100 assigned to the General Electric Company describes fuel cell stacks and a fuel cell module; and

4) G. J. Saunders et al. in 2002 in J. of Power Sources, Vol. 106, pp 258-263 describes the reactions of hydrocarbons in small tubular SOFC's.

5) A. V. Virkar et al. in U.S. Pat. No. 5,543,239 disclose an improved electrode design for solid state devices, fuel cells and sensors.

6) Y. Shen et al. in U.S. Pat. No. 5,624,542 disclose an enhancement of mechanical properties of ceramic membranes and electrolytes for cells.

7) S. H. Balagopal et al. in U.S. Pat. No. 5,580,430 disclose selective metal cation-conducting ceramics useful in electrochemical cells.

8) A. V. Virkar et al. in U.S. Pat. No. 6,106,967 disclose a planar solid oxide fuel cell stack with metallic foil interconnect.

9) A. V. Virkar et al. in U.S. Pat. Nos. 6,054,231; 6,326,096 disclose a solid oxide fuel cell (SOFC) interconnector having a superalloy metallic layer. The metal layer is a metal which does not oxidize in a fuel atmosphere, preferably nickel or copper.

10) J. W. Kim et al. in U.S. Pat. No. 6,228,521 disclose a high power density solid oxide fuel cell having a graded electrode.

11) N. P. Brandon, S. Skinner, and B. C. H. Steele, Ann. Rev. Mater. Res. 2003. 33:183-213 describe recent advances in materials for fuel cells.

12) W. Z. Zhu and S C Deevi, Mat. & Eng. A-Structural Materials, 362 (1-2): 228-239 Dec. 5, 2003 review recent progress in Anode Materials for SOFC technology.

13) R. A. Cutler and D. Laure, Solid State Ionics, 159, 9-19 (2003) review recent advances in cathode materials for SOFC Technology.

14) F. Tietz, H.-P. Buchkremer, D. Stoever, Solid State Ionics, 152-153, 373-381 (2002) review world-wide processing technology of SOFC components.

15) L. C. De Jonghe, C. P. Jacobson and S. J. Visco, Ann. Rev. Mater. Res. 33:169-82 (2003).

16) T. Fukui, et al., J. Power Sources 125, 17-21 (2004) review how to control the Ni-YSZ anode material.

17) T. Fukui, et al., Journal of the European Ceramic Society 23 (2003) 2963-2967, review the performance and stability of the cathode material based on Ni (NiO) and YSZ.

18) S. P. S. Badwal, Solid State Ionics 143, 39-48 (2001) review the stability of SOFC components.

19) C. Axel, et al., Solid State Ionics, 152-153 537-542 (2002) review the development of multilayered anodes for SOFC.

20) J. T. Richardson, et al., Applied Catalysis A 246, 137-150 (2003) describe the reduction of NiO to Ni, which is the conduction phase in the YSZ-Ni anode material.

21) P. Costamagna, et al., Chem. Eng. J. 102, 61-69, describe a flat panel SOFC stacking design where cells are side by side.

22) C. S. Montross et al, British Ceramic Transactions (2002) Vol. 101 No. 3, 85 describe the determination of stress and strain in a SOFC by a mechanical analysis.

23) High-Temperature Solid Oxide Fuel Cells: Fundamentals, Design and Applications, S. C. Singhal, K. Kendall, Published by Elsevier, 2003, ISBN: 1856173879 includes reviews of technology used in solid oxide fuel cells.

The U.S. patents, patent applications, and U.S. patent publications cited herein are incorporated by reference in their entirety.

These cited references and the general references of the conventional art continue to have significant thermal transfer and stress problems, which can result in lowered efficiency and/or premature failure of the fuel cell. The present invention provides at least one way to overcome these problems.

### SUMMARY OF THE INVENTION

The present invention concerns a power generating device comprising:
a plurality of tubular solid oxide fuel cell elements being electrically connected to each other to define a collecting cell;
first and second current collecting means being connected to a location on the positive electrode and and a location on the negative electrode which is external to the hot active reaction zone of said collecting cell, respectively;
a power generating chamber containing a cell, itself comprising a combined unit of a fuel gas chamber, an oxidizing gas chamber, and the SOFC;
an oxidizing gas chamber as a separate part from the power generating chamber by a partition;
an oxidizing gas supply means for supplying an oxidizing gas from said oxidizing gas chamber into an internal space of each solid oxide fuel cell element through the partition;
fuel gas supply means for supplying a fuel gas from said fuel gas chamber to said power generating chamber through said second partition, said oxidizing gas reacted electrochemically with said fuel gas to generate electric power by ionic transfer and migration through the partition; and
a fuel gas introducing means for introducing the fuel gas into said power generating chamber is substantially constant along a longitudinal direction of said solid oxide fuel cell elements, said fuel gas introducing means comprising fuel gas supply tubes arranged between said solid oxide fuel cell elements in a first direction to said solid oxide fuel cell elements.

In another embodiment, the invention includes a method of electric power generation utilizing a solid oxide fuel cell with a thermally insulating jacket such that the fuel cell is adjacent to a catalytic oxidation device, and such that the catalytic oxidation device is thermally integrated with the fuel cell;
delivering a mixture of air and fuel gas to a gas flow passageway such that the catalytic oxidation device is heated by oxidation of the fuel gas and/or by physical proximity to the fuel cell, and resultant oxygen-depleted gas is delivered directly to the fuel cell;
generating an electrical output as a result of electrochemical oxidation of the fuel gas in the fuel cell by ion transfer through a partition; and
injecting the fuel gas into a conduit connected to the gas flow passageway such that oxygen or air is drawn into the conduit and mixed with the fuel gas, wherein said solid oxide fuel cell device is the device of any of claim 1 to claim 12.

In another embodiment, the power generating device utilizes multiple reaction tubes as a stack having a first manifold located at one end of the stack having portions of the reaction tubes protruding wherein said first manifold is externally cooled, and a second manifold located at the other end of the stack having portions of the reaction tubes protruding wherein said second manifold is externally cooled.

In another aspect, the invention relates to a method of generation of electrical power, heat or combinations thereof, using the device of claim 1 below.

### BRIEF DESCRIPTION OF THE FIGURES

General: For the figures herein, the representative similar components may have a different shape but are the same and comparable to components in other figures. Also, the components track from the figures in U.S. Ser. No. 60/696,036.

FIG. 1A is a schematic representation of a cross section of a single tubular solid oxide fuel cell 10 of the Siemens-Westinghouse Corporation. It is conventional in the art.

FIG. 1B is an isometric schematic representation of a single tubular solid oxide fuel cell 11 of FIG. 1A.

FIG. 2A is a schematic representation is a schematic representation in cross section of cell-to-cell connections of the multiple cells 20 of FIGS. 1A and 1B.

FIG. 2B is a schematic representation in isometric view of the exterior of the cell-to-cell connections of FIG. 2A.

FIG. 3A is a schematic representation in isometric view of three cells bundled together.

FIG. 3B is a schematic representation in cross-section of a single cell without the interconnects.

FIG. 4 is a photographic representation in isometric view of the extension of a stack of planar fuel cells wherein each cell is connected electrically via a bi-polar plate.

FIG. 5A is a schematic representation in cross-section of how the fuel cell tubes of this invention are brought together.

FIG. 5B is a schematic representation in cross-section of the connected fuel cell tubes of FIG. 5A.

FIG. 5C is a schematic representation in cross-section as an enlargement of connections of the cells of FIG. 5B.

FIG. 6A is a schematic representation in cross-section of the novel cells showing spines 61.

FIG. 6B is a schematic representation in cross-section of the novel cells showing spines 62 outside and in contact with the center cell.

FIG. 6C is a schematic representation in cross-section of a six-pack cell configuration of FIG. 6B insulated from each other by material 66.

FIG. 7A is a schematic representation in cross-section of a hexagonal bundle of six fuel cells.

FIG. 7B is a schematic representation in cross-section is an array of seven close packed hexagonal cells into bundles of FIG. 7A separated by insulation 75.

FIG. 8A is a schematic representation in cross-section of an array of six cells similar to FIG. 7A having interior spines 81.

FIG. 8B is a schematic representation in cross-section of an array of seven closely packed arrays having six spines 85 on the exterior.

FIG. 8C is a schematic representation in cross-section of an array of seven closely packed arrays of FIG. 8B each separated by insulation 89.

FIG. 9A is a schematic representation in cross-section of an array of six cells having a center spine 91 see FIG. 7A.

FIG. 9B is a schematic representation in cross-section of the array of FIG. 9A having four additional cells to the block of six.

FIG. 9C is a schematic representation in cross-section of a bundle of 18 cells having four protruding external electrodes 95.

FIG. 9D is a schematic representation in cross-section of six bundles of FIG. 9C each separated by an insulator 98.

FIG. 10A is a schematic representation in cross-section of a single SOFC having an inner spine and an outer spine 103.

FIG. 10B is a schematic representation in side cross-section showing the inner electrical spine 101, the external electrode spine 103 sealed at each end with a porous material.

FIG. 11A is a schematic representation in cross-section of seven closely packed fuel cells each having a center spine 111 and six external spines 113.

FIG. 11B is a schematic representation in isometric view of the rotated left manifold of FIG. 11D. It shows the flow of the oxidizing gases and fuel gases through the cooled manifold 115.

FIG. 11C is a schematic representation in isometric view of the rotated right manifold. It shows flow of oxidizing gases and fuel gases through the cooled manifold 118.

FIG. 11D is a schematic representation in side cross-section of the seven cells of FIG. 11A with the manifolds of FIG. 11B and 11C.

FIG. 12A is a schematic representation in cross-section of six tubes connected to a center spine 121.

FIG. 12B is a schematic representation in isometric view of a manifolds 129 and 115A showing the flow of the gases.

FIG. 12C is a schematic representation in isometric view of a manifold 127 having insulating and cooling capability.

FIG. 13 is a schematic representation in cross-section of the tubes 131 having an elliptical shape.

FIG. 14A is a schematic cross-sectional representation of the fabrication of an SOFC stack with the formation of the electrolyte structure subdivided into 16 triangular channels.

FIG. 14B is a schematic cross-sectional representation of FIG. 14A after heating to create a dense structure. FIG. 14B usually shrinks during heating.

FIG. 14C is a schematic cross-sectional representation of FIG. 14B wherein the two electrode materials are deposited.

FIG. 14D is a schematic cross-sectional representation of FIG. 14C wherein the spines are inserted into each triangular channel.

FIG. 15 is a schematic representation in cross-section of typical anode-supported cells with five layers.

FIG. 16 is a schematic representation in cross-section of a tubular, anode-supported cell with spines 151.

FIG. 17 is a schematic representation in cross-section of the SOFC structure without a cathode current collector layer.

FIG. 18 is a schematic representation of the extruded structure made using cathode current collection material.

FIG. 19 is a schematic representation of a complete, sintered hexagonal structure of a bundle of seven tubes.

FIG. 20 is a schematic cross-sectional representation of the design of a silver rod 292 embedded in a ceramic spine 293.

### DETAILED DESCRIPTION OF THE INVENTION AND PREFERRED EMBODIMENTS

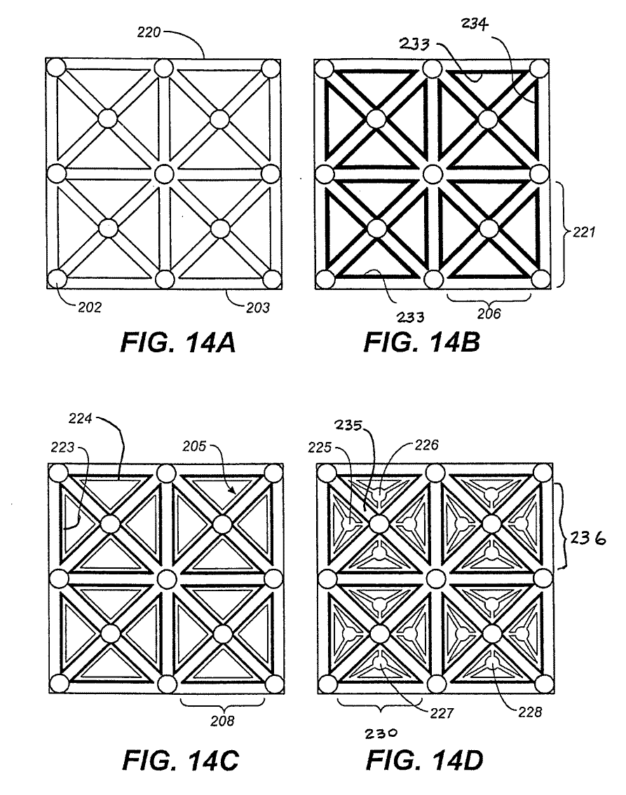

Definitions as used herein:
“Anode” refers to the negative electrode of a cell.
“Bundle” refers to an arrangement of cells that share a common external, porous electrode, and where the electrical connection between all cells within a bundle form a parallel connection. Bundles are electrically isolated from one another and can be electrically connected, one to another, either in a parallel or series electrical arrangement.
“Cathode” refers to the positive electrode of a cell.
“Cell” refers to a combination (configuration) of anode and cathode with an electrolyte there between and capable of functioning.
“Common material” refers to common metals and the alloys thereof, such as copper, iron, aluminum, chromium, titanium, cobalt, zinc, and nickel.
“Connection” or “connector” or “interconnect” refers to the connections made between individual cells within a bundle at both ends of the cells or between bundles of stacked bundles.
“Electrode” refers to either the anode or cathode that is separated by the electrolyte along the length of each cell, which also extends beyond the cell where it is joined in an electrical connection to form either a parallel or series arrangement of cells.
“Fuel” refers to the conventional fuels to be oxidized for the functioning of a fuel cell, such as hydrogen, alkanes (methane, ethane, propane, butane, pentane, hexane, etc.) alkenes (ethylene, propylene, butylene, isopentene, pentene, etc.), alkynes (acetylene), methanol, ethanol, syngas, or other hydrocarbons which are conveniently gasified to form a gaseous mixture of predominantly hydrogen and carbon monoxide; and also various liquid fuels, which can also be gasified to form a gaseous mixture of predominantly hydrogen and carbon monoxide, etc.
“Internal Spine” refers to the spine that is located within each tubular cell. It is bonded to the inner, porous electrode and reduces the electrical resistance for current flow from the inner porous electrode to both ends of the cell where it is connected to other cells within a bundle of cells or other bundles within a stack.
“Manifold” refers to the component of either the bundle or stack that serves to direct the fuel and air to their appropriate electrodes within each cell; this component also electrically isolates the cathodes and the anodes of adjacent cells; it also allows the cooling of the ends of the cells and their electrodes by way of either radiation cooling or fluid cooling.
“Oxygen” or “air” refers to the oxidizing reactant or oxidant for the fuel cell.
“Polymer” refers to the polymer combined with structural material and then extruded, FIG. 14A. FIG. 14A is heated to remove the polymer to shrink and harden the structure and density, see FIG. 14B.
“Shape” refers to the various configurations of components of the cell and include but are not limited to tubular, round, triangular, square, rectangular, elliptical, oval and the like.
“SOFC” refers to solid oxide fuel cell.
“Spine” refers to the component that is bonded to either the inner porous electrode or the outer porous electrode along the length of the tubular cells. The primary purpose of the spine is to decrease the resistance of electrical current that flows along each cell to the external connections. The spine extends beyond the length of each cell, into the manifold, to allow connection to other cells in the cooler (or cooled) region at both ends of the cells and to the bundle of cells. The secondary purpose of the spine is to provide mechanical support to the bundle of cells.
“External Spine” refers to the spine that is bonded to the outer, porous electrode of more than one cell and reduces the electrical resistance for current flow from the outer porous electrode to both ends of the cell where it is connected to other cells within a bundle or to other bundles in a stack.

### DETAILED DESCRIPTION OF THE INVENTION AND PREFERRED EMBODIMENTS

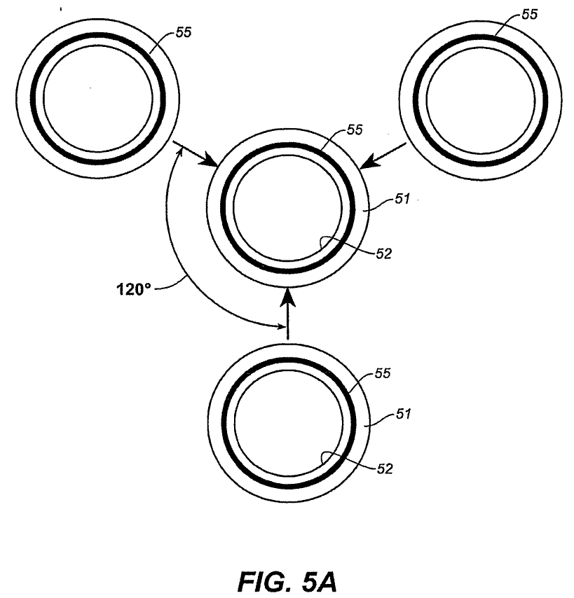

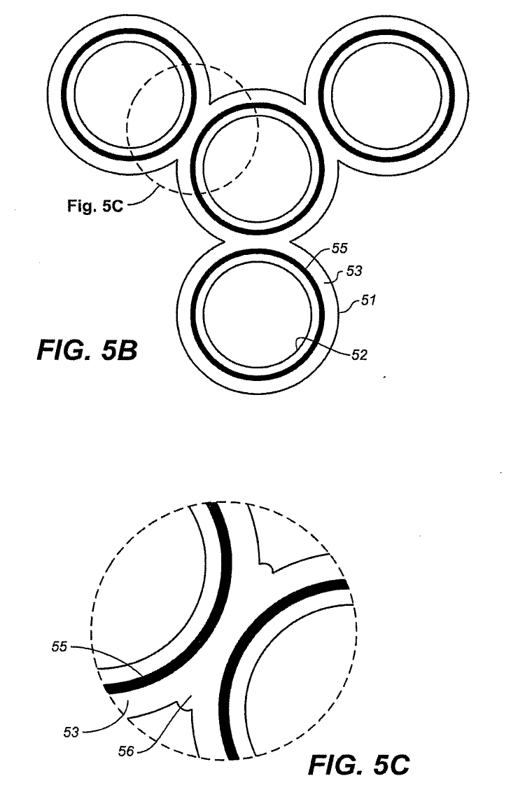

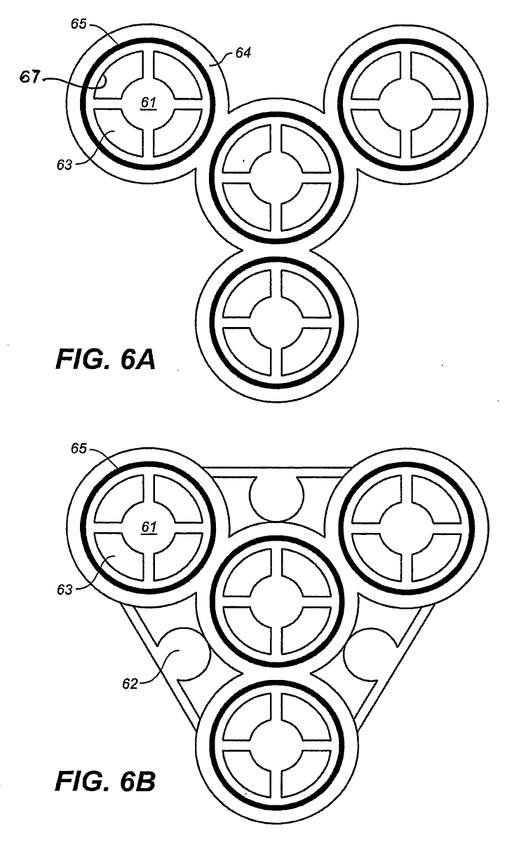

As is shown in the figures, particularly in FIGS. 5A, 5B and 5C, the cross section of individual tubular solid oxide fuel cell that is the basic element that comprises the disclosed novel design. Although those shown in FIGS. 5A, 5B and 5C have a circular cross section, their cross-section need not be circular. The tubes have any length, but the length to diameter ratio should not exceed a limit where the stress on the outer surface of the tube, produced by bending when the tube is not fully supported, exceeds the strength of the tube. In addition, the tubes cannot be of indefinite length in order to minimize voltage losses associated with the resistance to transporting electrical current along the length of the tube.

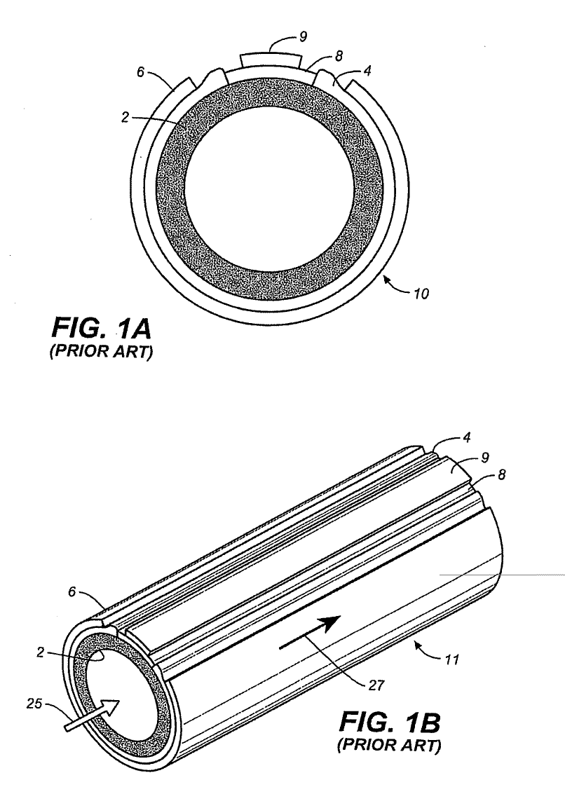

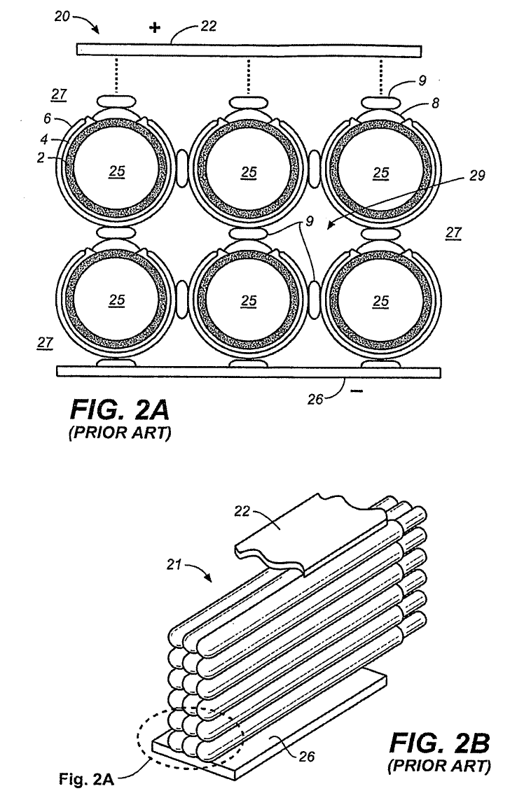

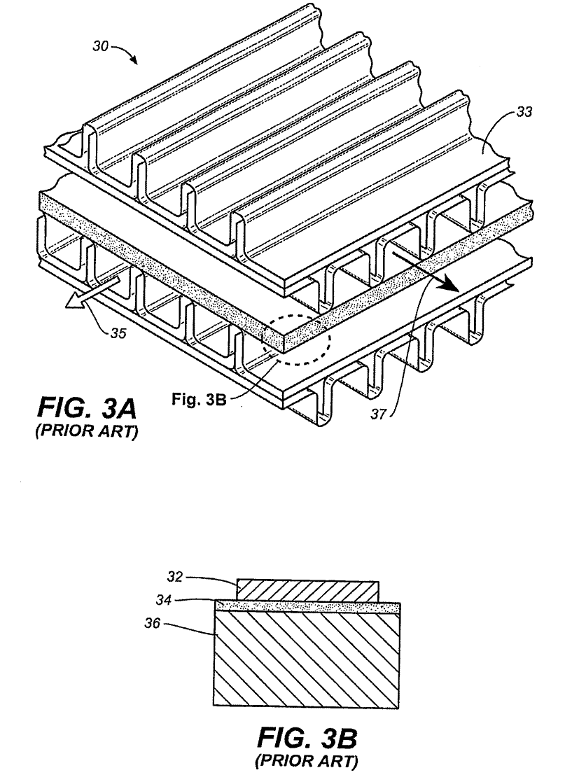

The tubes are formed with the porous anode and cathode materials that sandwich the dense electrolyte material 55. The porous anode material 52 is either the inner surface (inner diameter) of the tube (thus the cathode 51 is the outer material), or the outer surface (outer diameter) of the tube; either configuration is acceptable. Of course, if the inner surface is the porous anode material, the outer surface must be the porous cathode material 51, or vice versa. On the other hand, different from the SOFC tubes used in the Westinghouse (now Siemens-Westinghouse) design, all three materials (porous anode and porous cathode, and electrolyte) circumscribe the tube in the design disclosed here. (As shown in FIGS. 1A, 1B, 1C, and 1D, only one of the three materials, e.g., the porous cathode material 2, circumscribes the tube in the Westinghouse design. In the Westinghouse design, because the connection between the cells in the stack are made within the hot active zone 29 of the stack itself, the other components, i.e., electrolyte 4 and porous anode 6, only partially circumscribes the tube so that an interconnect material 8 is connected from the inner porous electrode 2 (cathode) to the outer porous electrode 6 (anode) of the adjacent cell. In the current design, where all materials circumscribe the tube, the connections (namely, the interconnects) between the cells or bundles are made at the ends of the cell, not along their length as in the Westinghouse design. It is very important that the connections between the cells are made at the ends of the tubes, either with a connection directly to the porous electrodes, or to dense or porous spines that connect to the porous electrode materials as is discussed below. Interconnects, being outside the hot zone 29, are cooled to a lower temperature and thus are capable of being made of a good thermal and electrical conductor, e.g., copper.

In all cell designs, strains and stresses develop both during fabrication and during normal operation. These strains and stresses develop due to the different properties of the three materials that comprise the anode, the cathode and the electrolyte. During processing, each of the three materials may have a different shrinkage strain as powders that form the different components are made either stronger or denser during heating. Stresses sufficient to extend small cracks within the powder can cause larger defects that extend as cracks and cause delamination to occur during the heating process. Just as important, the strains and stresses that arise within each of the layers that form the tube are a problem when the tubes are cooled from the processing temperature and when they are thermal cycled during use as a fuel cell. These stresses generally arise due to the different thermal expansion (contraction) coefficients of each material, relative to one another.

One advantage of the tubular design disclosed herein, where all three materials circumscribe the tube, is that the continuous layers of the three different materials will produce a symmetric stress distribution, namely a condition were the stresses do not change from one place to another around the circumference of the tube. For the Westinghouse tube design, where only one of the three materials circumscribes the tube and two of the layers only partially circumscribe the tube and end abruptly, larger stresses arise where the layers terminate at an edge. On the other hand, the conventional Westinghouse tubes have a fourth material, the interconnect material 8 as shown in FIGS. 1A and 1B, this fourth material and its connection with the others give rise to stresses which are not present in the novel design disclosed here which comprises three materials that circumscribe the tube.

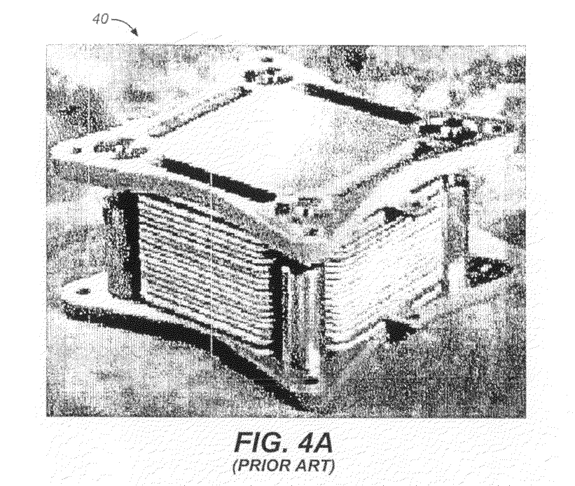

The type of fuel cell disclosed herein, where stresses are symmetric, has significant advantages over the planar cell, where the three materials are layered on top of one another to form layered sheets. Since these layers are not symmetric, namely, they are not mirrored relative to one another, stresses that arise within such a layered structure cause the structure to bend every time it is heated and cooled, namely, the structure ‘breathes’ in and out every time it is thermally cycled. That is, tensile stresses arise on one surface and compressive stresses arise on the other surface during thermal cycling. This condition is further exacerbated when the metal, bipolar interconnect plates are attached to the planar SOFCs and more so when the planar SOFC are stacked together as shown in FIG. 4. It is not a surprise that one major failure phenomenon observed in the planar SOFC stack is delamination. As discussed below, when the novel tubular cells disclosed here are stacked together, the stresses are still symmetric and not subject to delamination.

The novel tubes shown in FIGS. 5A, 5B and 5C are made by a variety of methods, including the method used to manufacture the described Westinghouse SOFC tubes. Namely, in the Westinghouse method, tube manufacturing starts by extruding powder to make a thick walled tube of the cathode material that is then heated to produce a strong, thick walled porous tube. A gas phase reaction is then used to form a thin yttria-stabilized ZrO₂ (YSZ), dense layer oxide electrolyte on the outer surface of this porous cathode material. A slurry method can then be used to coat the outer surface, namely, the dense YSZ surface, with a metal powder such as nickel or its oxides and YSZ, that will produce the porous anode material after a high temperature treatment. Other tubular SOFC designs are also used to fabricate and manufacture the SOFC tubes. For example, in the Westinghouse design, the porous cathode material is the structurally supporting material. The same tube can be made where the porous anode material is the inner, structurally supporting material.

### Disclosure of New Stack Designs

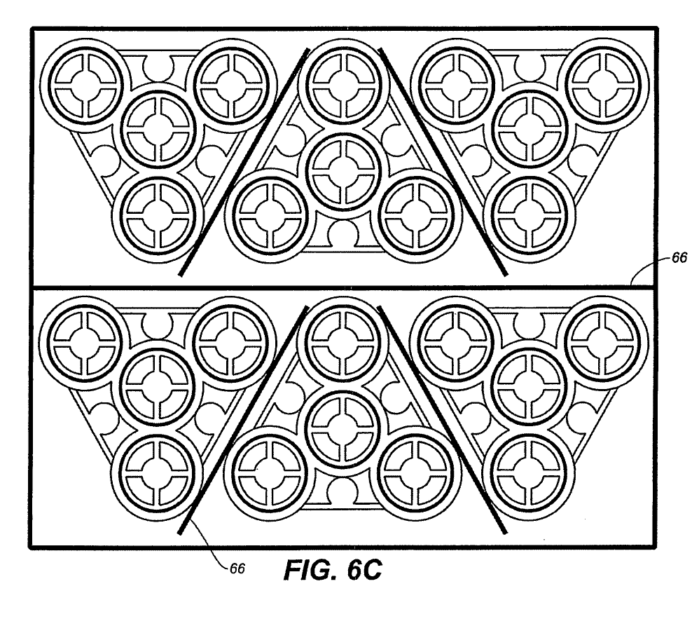

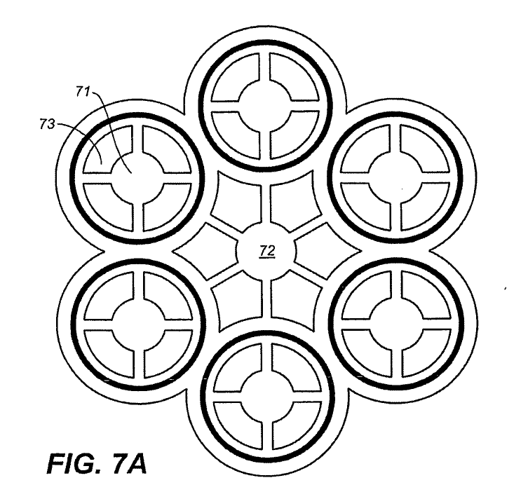

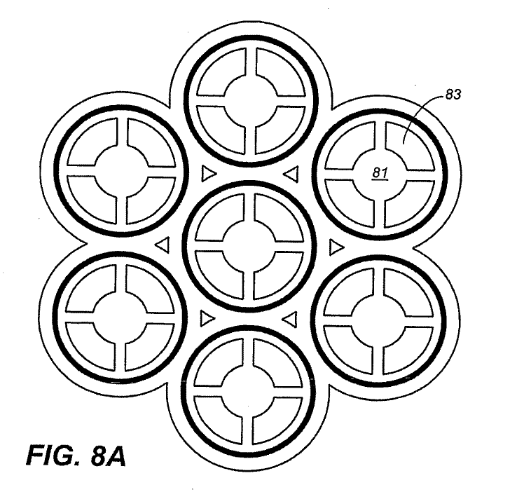

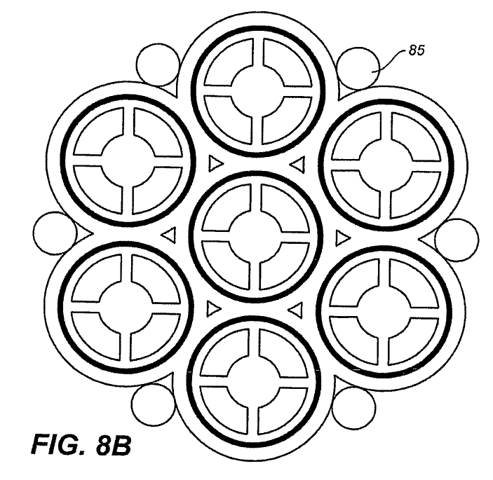

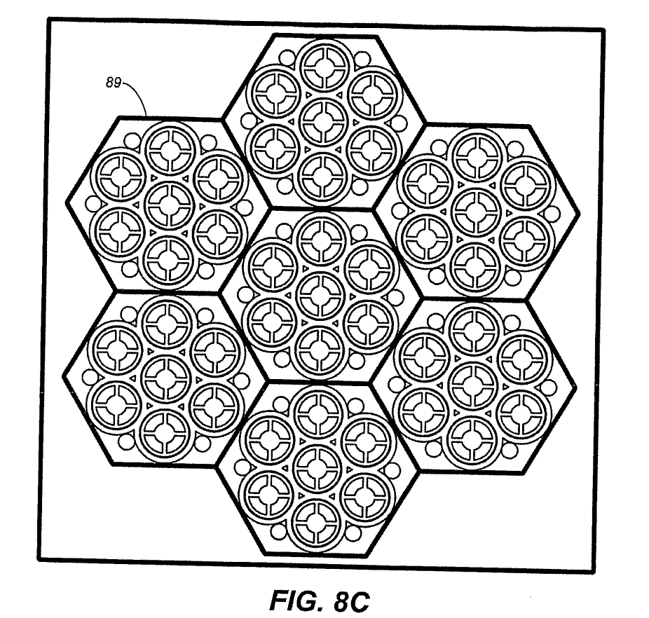

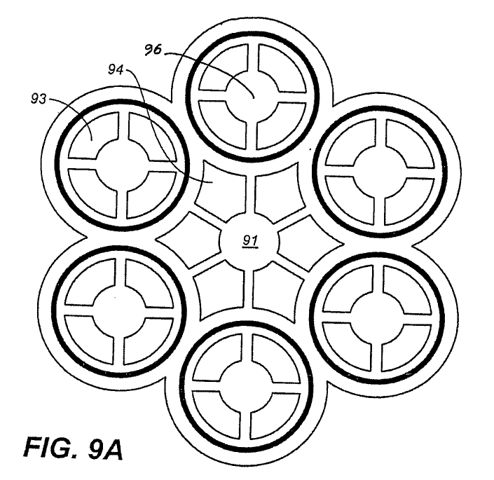

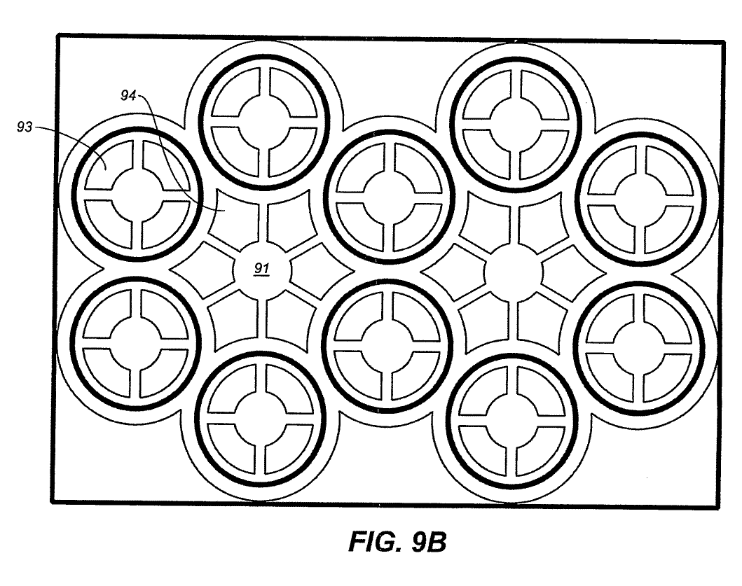

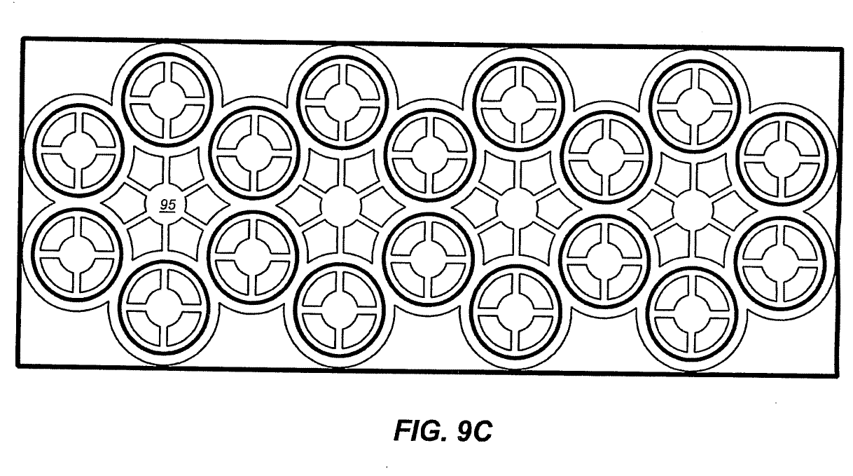

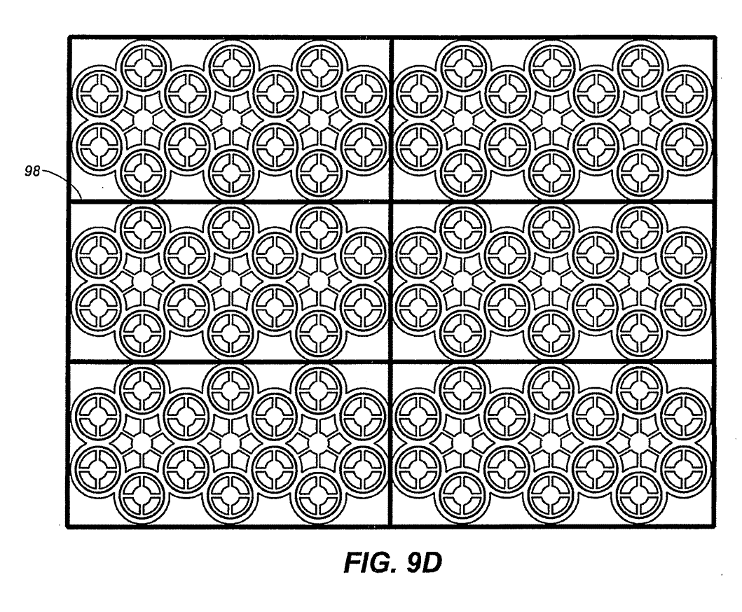

Another novel feature of the stack design disclosed here is the arrangement of individual SOFC cells. In this novel arrangement, shown in its simplest form in FIG. 5B, the outer porous electrodes 53 are connected together along the length of each cylindrical cell as illustrated in FIG. 5C. The common connection 56 of the outer, porous electrodes to one another allows for commonly shared structural supports between the cells as shown in FIG. 6B, and commonly shared electrodes such as those shown by number 62 in FIG. 6B and number 85 in FIG. 8B and 91 in FIG. 9A and 95 in FIG. 9C that can be extended beyond the cylindrical cells to be connected to adjacent cells at both ends of the stack. On the other hand, each of the inner porous electrodes is isolated from one another.

Stack Designs with Tubular Cells

These designs are discussed herein below.

### The Four Cell, Triangular Bundle

FIGS. 5A, 5B and 5C illustrate one basic bundle of tubular SOFCs that is formed with four cells, where three of the four tubes are bonded to the center tube at every 120° (FIG. 5A to 5B) to form a triangular bundle. The material 56 that bonds the tubes together (FIG. 5C) may be, but is not limited to, the same porous material that is used to produce the outer porous electrode material. Additionally, this material need not be porous. The configuration shown in FIG. 5B is the simplest of the new SOFC bundles that are stacked together. It is composed of four tubes.

Hollow metal tubes that serve both as an external electrode contact and a flow path to introduce the gas (either fuel or air) to the interior of the tube are fitted to make contact with the inner, porous electrode material. Optionally a metal felt is used as the material that produces a snug, nearly gas tight and electrically connected contact with the inner surface of each tube. The metal felt has a low elastic modulus and thus is sufficiently compliant to minimize stresses that arise due to the differential thermal expansion coefficients between the SOFC and the inserted tube. In this simple bundle, the outer surface of four cells is the other porous electrode; it is continuous and thus a common, connective electrode for all four cells. The four tubes are immersed in a gas, either air or fuel (opposite to the gas that flows through the tubes); this is easily done by placing the four tubes within an enclosure where either the fuel or air is introduced. An external metal electrode with the cross sectional shape of the four tubes can be affixed to each end of the four-tube bundle such that it mates with the external surface of the four tubes. A metal felt acts as a compliant layer to both ensure a electrical connection and to minimize stresses. The tubes that are fit into the inner diameter of each tube and electrically connected to the inner porous electrodes are the inner electrodes for each cell. One end of the bundle can be one electrode (outer electrode) and the other end of the bundle, the inner electrode.

Thus the arrangement shown in FIGS. 5A and 5B is a bundle of four cells; the outer electrode 51 is common to all four, and the inner electrode 52 is separate for each of the four cells. The electrolyte 55 is sandwiched between the anode and cathode electrodes 51 and 52. Since the outer electrode is common to all four cells, the four cells can only be connected in parallel when a load is connected to the outer electrode and the four inner electrodes. How a series connection is formed is discussed below.

When the external electrode is fixed to only one end of the bundled cells, it can be either the anode or cathode, and correspondingly the internal electrodes become the opposite electrode (cathode or anode, respectively) for the bundle. In this way, the four tubes can be connected in a parallel arrangement with both electrodes located on one end of the bundle.

It should be noted that as electrical current is generated by the stack, the current travels along the length of each tube, both through the inner, porous electrode material and through the outer, porous electrode material. Since both electrode materials exhibit a resistance to the flow of current, the tube will heat up as current is generated. Thus, to allow the use of inexpensive metals for the connecting, external electrodes and tubes to flow gas into the tubes, the external electrode contact should be cooled using either radiation or fluid cooling.

In conventional SOFC stacks, namely either the conventional Siemens-Westinghouse tubular design, or the planar stack design, the connections between the individual cells are within the hot zone of the stack, thus, preventing the electrodes from being cooled and preventing the electrodes from being made of an inexpensive metal with good electrical properties.

FIGS. 6A, 6B, and 6C show that two sets of spines (61 & 62) are introduced into the triangular bundle. One set, shown in FIG. 6A is called the internal spine 61, which is used to decrease the resistance of the current path from the internal porous electrode material for each tube within the bundle. The electrolyte 65 (same as 55 and often YSZ) is sandwiched between the electrode 64 and 67. The internal spines 61 are dense or porous, monolithic bodies containing a central cylindrical core, with a length that exceeds the length of the SOFC tubes, and at least two ribs 68 (four are shown) that extend the length of the SOFC tubes. There may be an advantage to making the spines porous. If they are porous, gas easily transports across the spine, thus ensuring a uniform pressure (or concentration) of the active species in the gas—oxygen in the oxidant, hydrogen or carbon monoxide or other fuel species in the fuel. This will ensure a uniform distribution of the active species over the electrode/electrolyte interface—thus ensuring good fuel and oxidant utilization, minimization of hot spots, and efficient operation. The internal spines are made of the same material used for the internal porous electrode or of some other compatible material. If the internal, porous electrode and the internal spine materials are identical, both will have the same thermal expansion coefficient despite the fact that one is porous and one is dense. Thus, residual stresses will not arise if both are made of the same material. Alternatively, the spines are made of porous materials.

FIG. 6B shows the external spines 62. Like the internal spines 61, the external spine 62 is composed of a cylindrical core, which may be porous or dense, that is bonded to the external porous electrode of the inner cylindrical cell, and also bonded to the two adjacent cells with a rib. Three of these external spines are used for the triangular bundle. Like the internal spines 61, the principal role of the external spines is to provide a lower resistance path for current. Channel 63 is open for passage of gas. A secondary role of the external spines 62 is to provide structural support for the triangular bundle. Likewise the same material should be used for the dense external spines as used for the porous external electrode that surround each of the four cells.

As discussed above, because the four cells within the triangular bundle share a common external electrode, the four cells can only be connected together in a parallel arrangement. This arrangement of four cells is called a bundle. But, if two or more triangular bundles are brought together as shown in FIG. 6C, then, provided that an insulating material (66), such as a refractory, electrically insulating felt (66) is used to separate the adjacent bundles, a large number of the triangular bundles can be placed together (only 6 are shown in FIG. 6C) connected in series to one another. The separators do not need to be continuous along the length of the cylindrical cells, but simply need to electrically isolate one from the other. By stacking the triangular bundles together, the external electrode (64) of one triangular bundle is connected to the internal electrode of the adjacent triangular bundle, and so on for connections along the line of adjacent triangular bundle.

### The Six Cell, Hexagonal Bundle

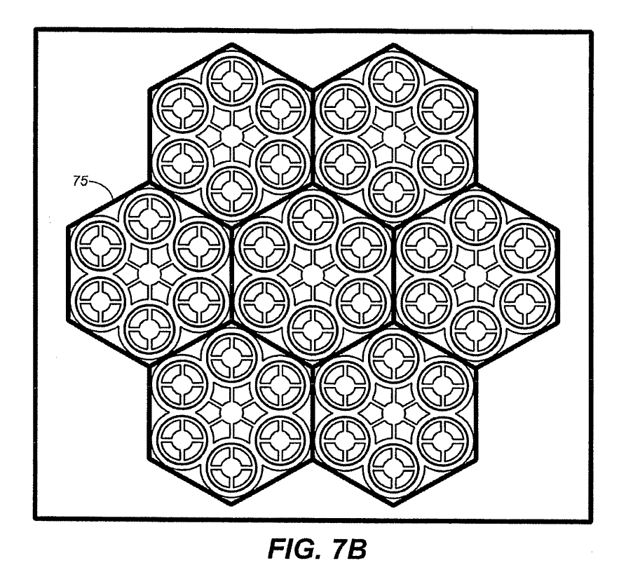

FIG. 7A shows the hexagonal bundle composed of six cylindrical cells, bonded to one another as shown in FIG. 5C. This arrangement of six cells is called a bundle. Each cylindrical cell contains one internal spine 71, which creates the channel 73 for passage of gas to reduce the resistance to current flow. The bundle contains only one external spine 72, which creates the channel 73 for passage of gas at the center of the array 70. It is bonded to the six surrounding cells by ribs. Although the principal role of the external spine is to reduce the resistance for current flow, it also has a structural role in supporting the surrounding six tubular cells. As for the four cells in the triangular bundle, the six cells within the hexagonal bundle also share a common external electrode 72 and thus, they can only be connected in parallel. FIG. 7B shows that a number of hexagonal bundles are placed together to form a stack. Because each hexagonal bundle is electrically insulated form one another, they can be connected in series to increase the voltage of the combined stack. The material 75 that electrically insulates one bundle from another can be a refractory felt or simply porous spacers that are electrically insulating. The insulating material that separates the hexagonal bundles does not need to be bonded to the bundles. It would be expected that bonding the insulating material to the individual bundles would create problems that would give rise to residual stresses due to differential thermal expansion, etc. Also, if bonded, it may react with the electrodes and spines, and adversely affect electrical conduction properties. It should be noted that although the insulating material between the bundles is not bonded to the bundles, it should aid in structurally supporting the stack of bundles.

FIG. 7B also shows that the array of hexagonal bundles of FIG. 7A that are contained in an enclosure in which the gas (air or fuel), is contained so it is in contact with the external porous electrodes of all the cells within the stack.

### The Seven Cell Hexagonal Bundle

FIG. 8A shows seven cylindrical cells bundled and bonded together. Each cylindrical cell contains an internal spine 81 creating channel 83 for passage of gas for improved electrical conduction. FIG. 8B shows the external spines 85 bonded to every two adjacent cells. And FIG. 8C shows an array of hexagonal bundles that can be connected together in a series arrangement. All are contained within an enclosure 89 that contains one of the two gases that contacts the external porous electrodes for each of the cylindrical cells.

### The Continuous Hexagonal Bundle

FIG. 9A to 9D are illustrations of how individual cylindrical cells can be connected together in a manner similar to that shown in FIG. 7A, but in a way that larger number of cylindrical cells can be continually added to one another to form bundles of six cells (FIG. 9A), ten cells (FIG. 9B), 14 cells (not shown), 18 cells (FIG. 9c), . . . 6+4n cells (n=number of external electrodes protruding the stack), each contained in an electrically insulating enclosure with a rectangular cross section. Each of these configurations can be called a bundle. Within each bundle, the tubular cells are connected in parallel (all external electrodes 91 connected together, and all internal electrodes 96 connected together) outside of the hot box. The gas in contact with the external electrodes is contained within the enclosure. The second gas, that in contact with the internal electrode, is fed though the center of each cell and is thus isolated from the external gas. FIG. 9D shows the stacking of six bundles (a case where each bundle has 14 tubular cells), each electrically isolated from one another. When the cathodes from one bundle are connected to the anodes of an adjacent bundle, the two bundles are connected in series. The open area of the space 94 in relation to the size and area of the spine has special significance. The area fraction of the open portion of the space must be large enough to allow useful passage of the gas in relation to the electrons transferred and current generated. In other words, if the area fraction of the external spine 91 within the region between the cells is too large, the passage of gas needed to generate current would be too small to produce a practical SOFC. Likewise, if the area fraction of the spine within the passage is too small, it would not significantly reduce the resistance to current flow to the ends of the stack. It is expected that the area fraction of the spine within the passage will be between about 0.05 and 0.95, preferably between about 0.10 and 0.40 and more preferably between about 0.20 and 0.25. It is expected that the optimum area fraction 93 of the spine also depends on the electrical load and also on the electrical conduction properties of the spine. The same type of area fraction exists for inner spine located in the space, within each cell. In such a manner, all bundles are connected in series to increase the output voltage.

### Manifolds for Confining the Gas Flow and Access to Inner and Outer Electrode Material

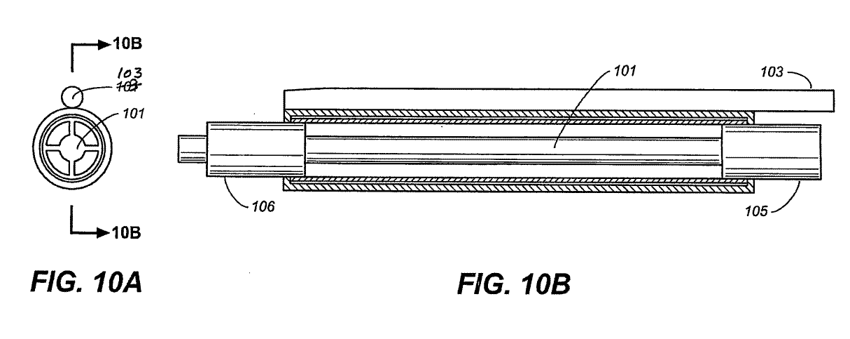

The different stack configurations and the bundles that are stacked together all have electrodes (internal and external spines) that extend beyond the cylindrical cell as shown in FIGS. 10A and 10B for one cylindrical cell. FIGS. 10A and 10B show the external electrode (103) extends beyond the cylindrical cell on one end, and the internal electrode (101), extending beyond the cylindrical cell at the other end. Since the cell generates heat as it generates voltage and current, a design with the electrodes extending beyond the cell, out of the hottest zone, is very desirable since the ends of both electrodes are cooled either by radiation, or cooled gas, or cooled water, when properly engineered. As shown in FIG. 10B, when the electrodes extend beyond the cell, one on one end, and the other on the other end, one end becomes the cathode, and the other becomes the anode. But, not shown in FIGS. 10A & 10B is a different configuration, where both electrodes extend beyond the cylindrical cell at one of the two ends, or at both ends. In such cases, the anode and cathode are found at the same end, or both ends of the cell. All three electrode configurations can be useful for different designs where individual cells are connected together in either a parallel or a series arrangement.

FIG. 10B also shows that the two gases (fuel and air) must be kept separate from one another, and that one gas (either fuel or air, depending on the composition of the internal and external porous electrode materials) must flow through the center of the cylindrical cell, whereas the other gas must be in contact with the external, porous electrode material. The cell shown in FIG. 10B is within an enclosure (not detailed) that contains one of the two gases. Thus, since the second gas must be confined to flow through the interior of the cell, flow tubes must be fitted to the tube to confine the flow of the gas to the interior and keep this gas separated from the other gas on the external portion of the cell. The tubes (manifolds) 105 & 106 are shown to fit within the tube and sealed in some manner so the seal is more or less, gas tight. Although the sealing conditions and materials are not detailed in this disclosure, the seal is a chemically bonded seal, e.g., a seal made from glass, ceramic, or metal powder that is heated after the flow tube is placed within the cell as shown in FIG. 10B, separated by said powder. At the desired temperature, the powder (glass, ceramic, metal) either sinters or flows to bond the tube to the interior of the cylindrical cell. The flow tube itself is made from either an electrically insulating ceramic (or glass-ceramic), or from a metal. Metal tubes are used since the flow tubes can be cooled as indicated above and discussed in more detail below. If the flow tube is made of a conduction metal, it is directly connected to the inner spine such that both the spine and the flow tube provide a continuous path for the transport of electronic current. If the flow tube is made of an insulating material (glass or glass-ceramic), then only the spine (shown to protrude beyond the flow tube) is the conduit for the passage of electronic current.

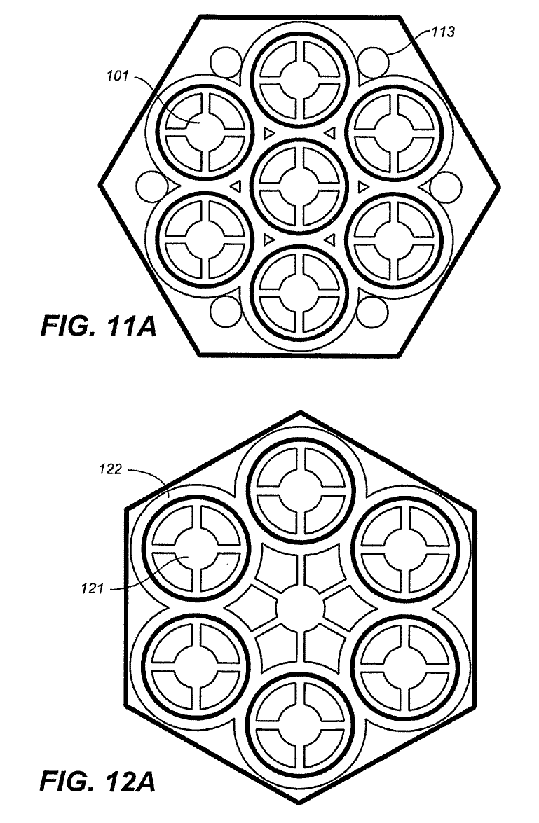

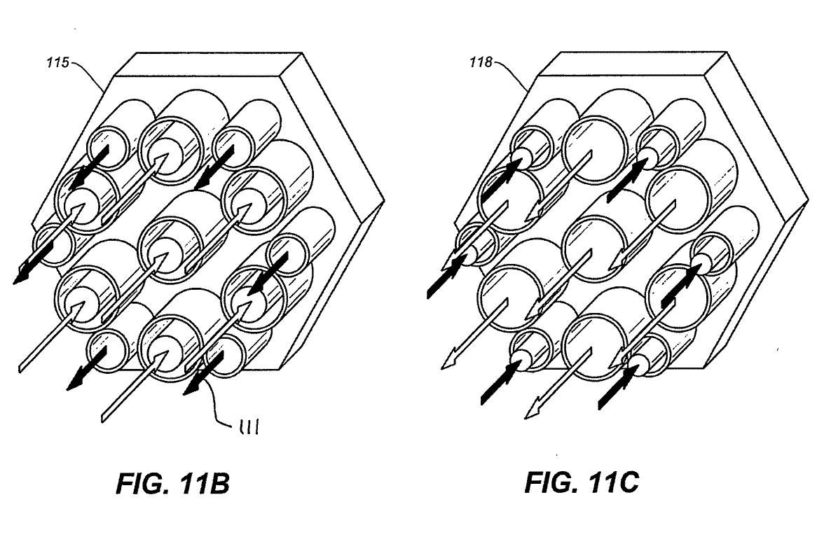

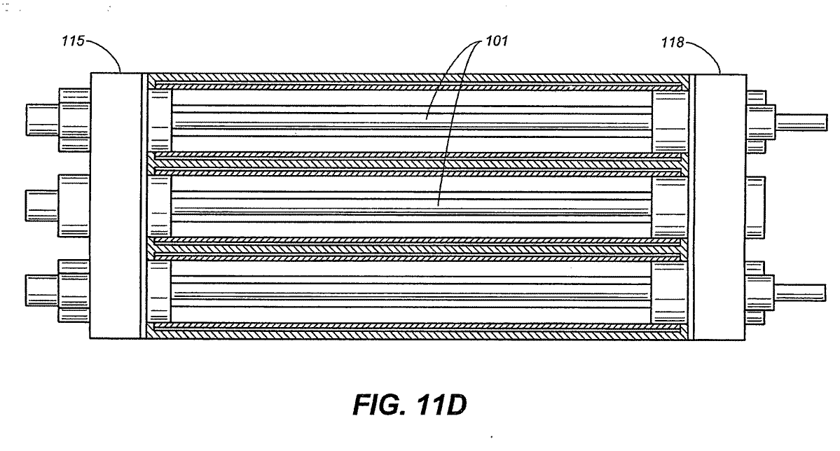

FIGS. 11A, 11B, 11C and 11D show that when more than one tubular cell is stacked together, and an external enclosure is used to confine the gas that must flow past the porous, external electrode, all of the flow tubes, a set of flow tubes used for the gas that must flow through the interior of each cell. A set that is used for the gas that flows pass the porous, external electrode material, is combined by forming a manifold that holds both sets of tubes, yet allows the electrodes to extend for connects for within the stack and from one stack to another. Since both the anodes and cathodes extend beyond the hot zone, the manifolds are made of a metal that is either sufficiently oxidation resistant (such as a super alloy or a stainless steel) that does not need cooling, other than radiation cooling, or a less oxidation resistant metal (an iron alloy) that may need air or water cooling within the manifold. In this latter case, the manifold has a double wall for the flow of cooling air or cooling water, or has cooling pipes, which are welded to the external portion of the manifold to produce the desired temperature.

The manifold shown in FIGS. 11B, 11C and 11D is fitted to the exterior enclosure with a reasonably gas tight seal so that the gas introduced to be in contact with the porous, external electrode can be introduced through one of the two manifolds (one of the two ends of the hexagonal stack), made to flow past the external porous electrode, and allowed to exit through flow tubes in the opposite manifold (the one at the other end of the stack). The flow of the external gas, in contact with the porous, external electrode, is shown by dark arrows 111 in FIG. 11B, 11C and 11D. The second gas, i.e., the gas that is in contact with the porous, inner electrode 101 is passed though the flow tubes bonded (or sealed) to the interior diameter of each of the tubular cells. This second gas is introduced at one end (through the flow tubes that protrude from the manifold) and exits the other end (through the flow tubes that protrude from the manifold at the other end of the stack).

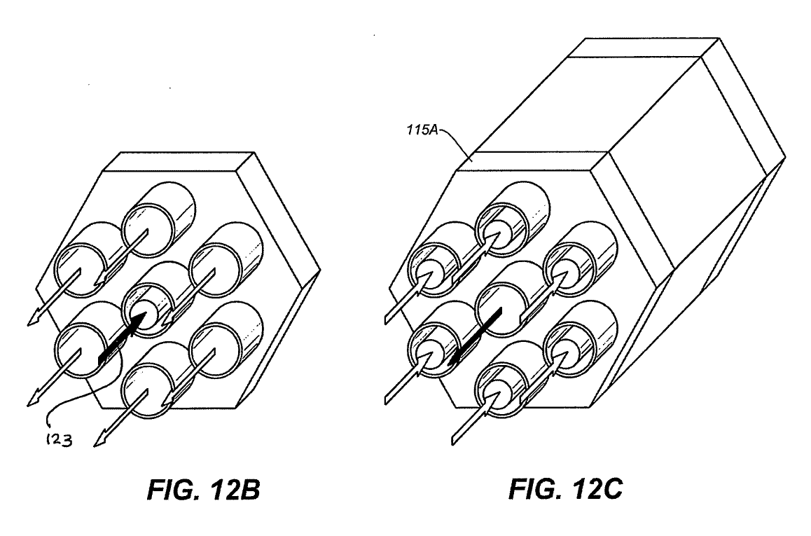

FIGS. 12A, 12B, 12C show a nearly identical configuration; however, this stack has the six-cell hexagonal configuration. In this design, the gas 123 that must be in contact with the porous, external electrode material is introduced via the center flow tube. The gas entering this tube will not flow though the six cylindrical cells within the stack, but will flow around all of the cells, always in contact with the porous, external electrode material 122. This gas introduced at one end, will exit the other end of the stack, depleted of the reactive component (oxygen at the cathode, and hydrogen or hydrogen+carbon monoxide at the anode) and enriched in the inert (for example nitrogen) or reacted (for example water vapor or water vapor+carbon dioxide) components though the central flow tube. The second gas, namely the one in contact with the porous, inner electrode material 121, is made to flow though the flow tubes that are sealed to each of the cylindrical cells as discussed above. Other features of the manifolds would be similar to those discussed for the stack shown in FIG. 11D.

Other stack configurations, such as that shown in FIGS. 6 and 9 will have similar manifolds. Also, when cells are combined as bundles to be connected in series, each bundle either has its own set of manifolds, or the manifold is designed to accommodate all of the different bundles.

In addition, although not shown in FIGS. 11B, 11C and 11D and 12B and 12C, if the flow tube is made of a non-conducting material, the electrode rod must be brought through the flow tube to make an electrical connection. On the other hand, if the flow tubes are they are simply connected to the electrode rods or the spines. In this case, the two different types of flow tubes (one used for one gas and one set of electrodes, and the other for the other gas and the other set of electrodes) must be electrically insulated from one another.

### Non Circular Cell Cross-Sections

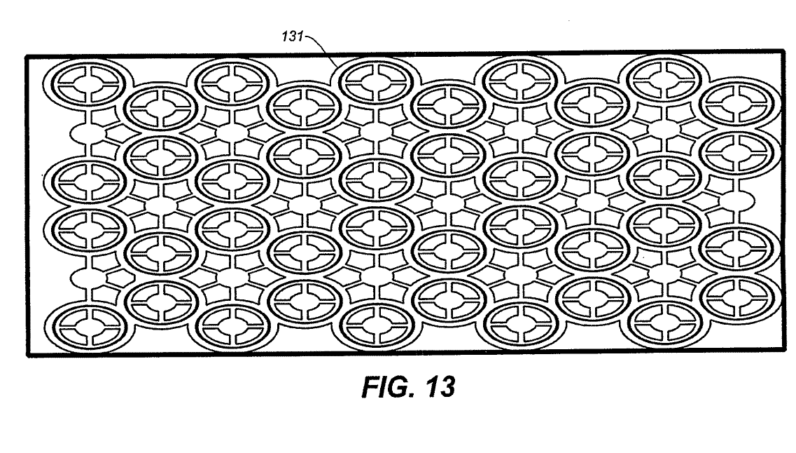

FIG. 13 shows that the cells need not be circular; there they are shown to be elliptical (131). The elliptical shape is advantageous because it increases the surface area of the electrolyte per unit volume, and thus, the stack, composed of the same number of cells as for the design with the circular cross section, produces more energy per unit volume, as it is more compact.

### Triangular Cells Without a Common External Electrode

Another embodiment of a triangular solid oxide fuel cell includes a configuration of bundles of cells that do not share a common electrode. This is different from the stack described above, where all cells within a bundle share a common, exterior electrode, this embodiment is composed of triangular channels where each triangular channel contains either the cathode spine or the anode spine. FIGS. 14A to 14D describe the sequence in which this type of stack is fabricated. The first of these figures, FIG. 14A, shows that the electrode material 220 is extruded through a die that forms multiple triangular channels as one integral unit. The outer geometry has a square cross section as shown. The structure shown in this FIG. 14B contains 16 (four within each smaller square) triangular channels. Structures with more triangular channels can also be used in this example. The electrolyte material 220, 202 or 203 are used to form this structure. Extrusion is a common method for forming such an integral unit. The general method starts with mixing the electrolyte power with a polymer that will enable extrusion through a die opening to form the desired structure, for example, that shown in FIG. 14A. Many more triangular channels can be extruded at one time. The size of the triangular units is only limited by the extrusion technology. Each can range in size between about one-half a millimeter and 50 millimeters, measured along the hypotenuse of the triangle. The length of the tubular structure composed of the triangular channels can be as small as the channel size or about 50 to 100 times the channel size. Smaller channel dimensions produce a higher power-density fuel cell. Note that extrusion is the forming method to make ceramic substrate structures for catalytic converters found in all automobiles.

After the structure is extruded, it is heated in a furnace to first burn off, or decompose, the polymer used to produce a plastic power mixture that enables the extrusion. This decomposition takes place at lower temperatures (between about 100° C. and 1000° C., preferably between 150 and 900° C.); the heating rate in this temperature range is very low, for example 1° C./minute, to avoid disruption during polymer decomposition, which produces gases, which is well known for this processing method. After the polymer is decomposed, the temperature is then increased to densify the electrolyte. For example, if the electrolyte material is yttrium stabilized zirconium oxide, then the temperature is raised to 1200° C. to 1600° C., preferably between 1300 and 1500° C., depending of the power characteristics, which are well known to those of skill in the art. Densification produces shrinkage, thus the dimensions of the dense electrolyte structure is smaller than is shown in FIG. 14B. In the next step shown in FIG. 14C, the inside surfaces of the triangular channels 206 and 221 are coated with the anode material 223 and cathode 224 materials; different coating methods are used, including slurry coating. Anode spines 225 and cathode spines 226 that are previously separately extruded are now inserted into their respective triangular channels as shown in FIG. 14D. Namely, the surfaces coated with the anode material 223 and the anode spine 225 are made to contact one another to provide the flow of an electrical current after the stack is heated again to bond the coating and spines together. Likewise, the surfaces coated with the cathode material 224 and the cathode spine 226 are made to contact one another and bonded together during a heat treatment. During heating, the spines are bonded to their respective coatings, and the two types of coats are partially densified to increase strength, yet produce the required porous electrode materials. These spines are designed to have a cylindrical core 227 and 228 with three vanes that extend into the corners of the triangular channels as shown in FIG. 14D. They are also designed such that the cylindrical cores, but not the vanes, extend beyond the triangular channels so that the cells can be connected together outside of the hot zone (as is described herein above).

FIG. 14 is also described as the fabrication of SOFC with anode 225 and cathode spines 226 using an extrusion method to form the multi-channel fuel cell structure 229. FIG. 14A is a cross section of an extruded power-polymer mixture forming the electrolyte structure of a multi-channeled structure subdivided into triangular channels 222 (FIG. 14B) same square tube shown in (FIG. 14A) after heating at high temperatures to produce a dense structure on which the two electrode materials 233 and 234 are deposited, as powders, in the adjacent triangular channels 223 as shown in (FIG. 14C). Any two adjacent triangular channels, separated by the electrolyte material 220 form one solid oxide fuel cell. Each triangular channel is part of three solid oxide fuel cells, namely, its surrounded by three other triangular channels that contain the opposite electrode. As shown in FIG. 14D the anode spine 225 and cathode spine 226 materials, composed as cylinders with three vanes, are inserted into each triangular channel to make contact with the electrode materials within the respective channel. At this point, all materials are heated to bond the spines to their respective electrodes within the channels and to produce the desired, strength and porosity for the electrode materials.

As shown in FIG. 14B and 14D, any one triangular channel 206 or 221 is either the cathode part of a cell (as 230) or anode part of a cell 236. The electrolyte 235 separates triangular cathode channels 233 from triangular anode channels 234. FIG. 14D also shows that a solid oxide fuel cell is defined as either one triangular cathode channel adjacent to three triangular anode channels, or one triangular anode channel adjacent to three triangular cathode channels. Because the triangular channels do not share a common electrode, the cells are electrically connected either in parallel or series.

FIG. 20 is a schematic cross sectional representation of a silver wire 292 embedded in a ceramic spine 293. The silver is used for its increased electrical conductivity and this spine is interchangeable with any of the spines described herein.

The following examples are provided for explanation and description only. They are not to be construed to be limits in anyway or factual.

### EXAMPLES

All materials for the individual fuel cells are conventional, namely, they are same as being currently used as the state of the art. Improved materials can be incorporated into the design, but they are not required for the novel design. The uniqueness of the disclosure lies in the stack design, not the materials.

Although the individual cells and their stack produce symmetric stresses that are not expected to produce bending strains under uniform temperature conditions, the choice of specific composition for each material should be made in an attempt to best reduce any thermal expansion mismatch.

### Components and Manufacturing

All components, namely solid oxide fuel cell with any cross sectional shape, dense or porous spines, etc. may be manufactured as separate components by companies under contract, university laboratories and the like. These components are then assembled to produce the stack design configurations described above. Bonding the components together is accomplished with conducting ceramic cements with nearly the same composition as the components. The bonding is usually accomplished with a heat treatment.

### Example 1 (Part 1)

### Fabrication of SOFC Design

### A Complete Bundle of Either Six or Seven Cells

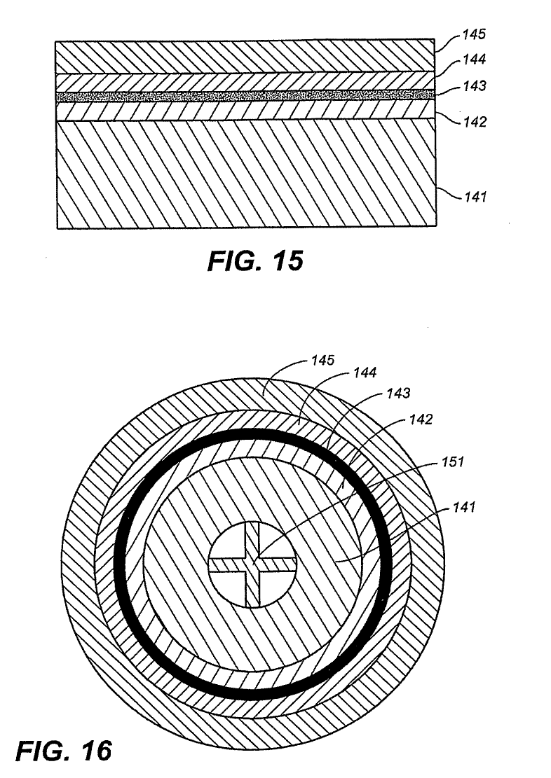

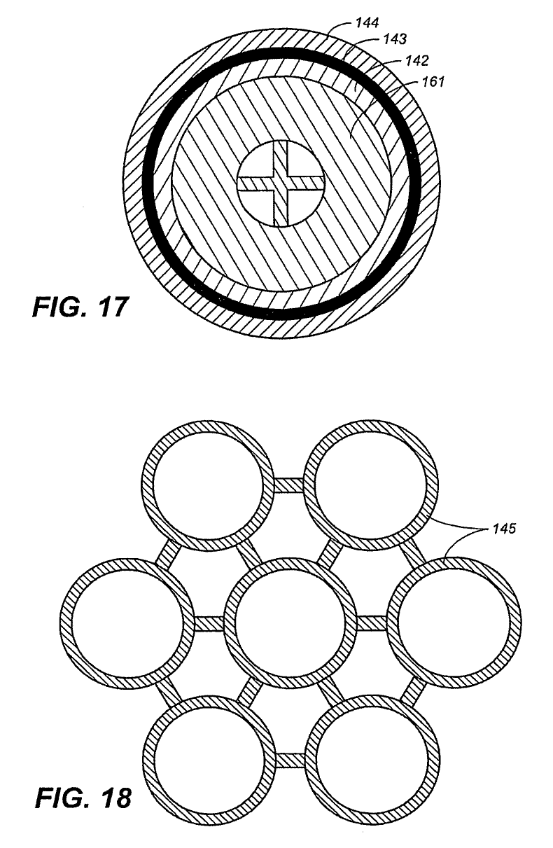

(a) Rationale: The fuel cell architecture is designed for minimizing voltage losses and thus for enhancing performance. For a given set of materials, this requires a careful control over microstructures of the electrodes (particle size, pore size, volume fraction porosity, and particle/particle contact morphology), the thickness of the electrodes, and the electrolyte thickness. A typical, high performance cell usually has at least five distinct layers (may be more). The schematic in FIG. 15 shows the various layers and the typical thicknesses for an anode-supported cell.

The fabrication procedure involves at least two steps, and possibly more. It is important that electrolyte, cathode interlayer and anode-interlayer thicknesses are on the order of a few microns or a few tens of microns. Also, microstructures in the interlayers must be very fine. The typical particle sizes in the interlayers are in fractions of a micron to a few microns.

Tubular geometry—Hexagonal structure: It is not generally easy to extrude a hexagonal structure with all of the layers maintained to precise tolerances, especially when one or more layers are only a few microns thick. One approach for fabricating the desired structure in a cost-effective manner is as follows.

The above structure (cross-section) is shown in a tubular geometry in the schematic of FIG. 16.

In order to produce the above structure without the cathode current collector, the following steps are followed:
Extrude the anode-support tube (141).
Apply a thin anode interlayer (142) (which is done by dip-coating or spray coating).
Apply a thin electrolye layer (143) (which is done by dip-coating or spray-coating)
Apply a thin cathode interlayer (144) (which is done by dip-coating or spray coating).

This process leads to the fabrication of the cell with first four layers, excluding the current collector layer. A schematic of the structure is shown in FIG. 15.

### Example 1 (Part II)

Fabrication of the Hexagonal Structure Using Cathode Current Collector Material: (The fabrication is done conveniently by extrusion. A schematic is shown in FIG. 16.)

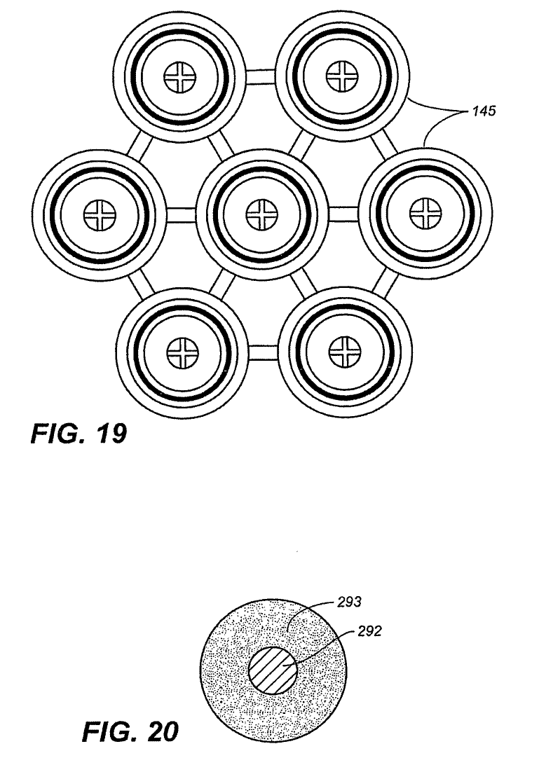

The extruded part (hexagonal structure) is such that circular openings are slightly larger than the outer dimensions of the anode support tube with three layers deposited on it. The anode-support tubes with three layers deposited on them then can be inserted into the structure shown in FIG. 18 or in FIG. 19. The particle sizes, porosities and sintering characteristics are so adjusted (through appropriate sintering optimization studies) that when sintered, excellent bonding occurs across all interfaces. The electrolyte should be fully dense (no connected porosity), while all other components should be porous with requisite microstructures. A schematic of the final part (a bundle) comprising all components is shown in FIG. 19.

(b) Similarly, when Example 1, Part I and II are repeated wherein the extruded anode support tube wall thickness is between 0.25 and 2.0 mm, the thin anode interlayer is between 1 micron and 100 microns, the thin electrolyte layer is between 1 micron and 100 microns, and the thin cathode layer is between 1 micron and 100 microns.

(c) Similarly, in Example I, Part I and II, (b) the internal spine has an area fraction relative to the area within the tubular cell that is between about 0.05 and 0.95.

(d) Similarly, in Example I, Part I and II (b), the external spine has an area fraction relative to the area external to the tubular cell that is between about 0.05 and 0.95.

### EXAMPLE 2

Fabrication of Triangular Cell Structure by Extrusion:

Triangular cell structure of the design shown in FIG. 14A-14D is fabricated by extrusion. Yttria-stabilized zirconia (YSZ) powder containing 8 mol.% Y₂O₃ and 92% ZrO2 of a fine particle size (approximately between 0.1 and 2 microns, from a commercial vendor, e.g., Tosoh, 1-7-7 Akasaka, Minato-ku, Tokyo 107 Japan) is used. YSZ powder is mixed with ethylene vinyl acetate (EVA) and stearic acid (CH₃(CH₂)₁₆COOH), from a commercial vendor such as Alfa Aesar, 26 Parkridge Road, Ward Hill, Mass. 01835-6904. The proportions are: YSZ: 80 wt. %, EVA: 10%, and stearic acid: 10%. A tool-steel or tungsten carbide die are designed and fabricated. The die has two sections. On the entry side, there are cylindrical holes placed in a regular arrangement. The diameter of the holes depend upon the flow characteristics of the YSZ+polymer mixture to be used, and the desired dimensions of the final cell structure. The diameter is anticipated to be between 0.1 mm and 10 mm. The length of the cell is between 5 mm and 100 mm. The length of the cylindrical holes is less than the length of the die. From the other side of the die, thin slots corresponding to rib structure given in FIG. 14A are machined. The width of the slots is in the range 0.05 mm to 0.5 mm. The length of the slots is between 2 mm and 30 mm. These slots meet the cylindrical holes somewhere in the middle of the die. The length of the slotted section is between about 5 mm and 50 mm. The total length of the die comprises the length of the cylindrical holes and the length of the slotted regions. The die is suitably positioned in an extrusion device.

The YSZ+polymer mixture is introduced into the cavity, and pressure is applied via a plunger. The YSZ+polymer mixture enters the side of the die with cylindrical holes, and exits from the side with slots resulting in structure shown in FIG. 14A.

The next step involves heating the extruded structure in a furnace. Initially, it is heated slowly, at a rate of about 1 degree/min to about 600 or 700° C. to burn out all organic matter without deforming and/or cracking the structure. Then the temperature is raised to about 1400° C. The heating rate for the latter step is much higher; and is anticipated to be about 10 degrees per minute. The temperature is maintained at 1400° C. for 1 hour. The furnace is cooled to room temperature. This procedure leads to the formation of the structure shown in FIG. 14B, which is next hardened (no polymer), and is nearly fully dense. Decrease in porosity leads to the occurrence of shrinkage. For this reason, the dimensions of the structure in FIG. 14B are smaller than in FIG. 14A.

Cathode spines are made of La_{0.}Sr_{0.2}MnO₃ (LSM), obtained from a commercial vendor such as Praxair Specialty Ceramics; 16130 Wood-Red Road #7, Woodinville, Wash. 98072. LSM powder of about 0.1 to 2 micron size is mixed with EVA and stearic acid in the same proportions as for the YSZ electrolyte. A tool steel or tungsten carbide die is designed with die cavity which upon extruding the LSM+polymer mixture will yield the spine structure, is designed and made. The mixture extruded to form the spines. The spines are then heated in a furnace slowly (˜1 degree/min.) to about 600 or 700° C. to remove organic matter without deformation and/or cracking. Subsequently, the temperature is raised to 1250° C. at a rate of about 10 degrees/min, and maintained at temperature for 1 hour. The furnace is next cooled to room temperature. This procedure leads to the fabrication of cathode spines. The die size is designed such that the fabricated spines can slide into the triangular cavities of FIG. 14B with very small clearance such that spines touch the YSZ structure.

Similar procedures are then used for fabricating anode spines. A mixture of NiO and YSZ, each of 0.1 to 2 micron particle size, are made containing 70 weight % NiO and 30 weight % YSZ. NiO+YSZ+polymer mixture are extruded to form anode spines. The spines are heated in a furnace slowly (1 degree/min) to about 600 or 700° C. to remove organics without deformation and/or cracking. Then the temperature is raised to 1400° C. (10 degrees/min). The temperature is maintained for 1 hour, and the furnace is cooled to room temperature. This leads to the fabrication of the anode spines. The dimensions of the extrusion dies are so designed that the spines just slide into the triangular cavities of FIG. 19B.

Cathode and Anode: A mixture of LSM and YSZ is made such that each component is in equal weight proportions. This slurry is made in a suitable liquid, such as ethanol. Alternate triangular cavities of the structure shown in FIG. 14B are coated with the slurry. The layer thickness is between about 20 microns and 200 microns. A mixture of NiO and YSZ is made with each component in equal proportions. Slurry of the same composition is made using a suitable liquid such as ethanol. The remaining triangular cavities are coated with this slurry. The typical thickness is between about 20 and 200 microns. FIG. 14C shows the schematic after these steps.

The cathode spines are inserted into the triangular cavities coated with LSM+YSZ. Anode spines are introduced into the triangular cavities coated with NiO+YSZ. The structure is heated to a temperature between 1100 and 1250° C. for one hour to form adherent and strong cathode and anodes, which are still porous. FIG. 14D shows the final schematic. The NiO is next reduced to Ni during the first heat up once a reducing gas is introduced into the anode cavities. For the example just described, the anode spines are be porous since they contain initially NiO, which is reduced to Ni forming porosity. Alternate possibilities for fabrication of the anode spines exist.

While only a few embodiments of the invention have been shown and described herein, it is apparent to those skilled in the art that various modifications and changes can be made in the design and materials to produce improved fuel cells, and the production of power and/or heat thereof without departing from the spirit and scope of the present invention. All such modifications and changes are intended to be carried out thereby.

1-35. (canceled)

36. A power generating device comprising a plurality of tubular solid oxide fuel cell elements, wherein each tubular solid oxide fuel cell element comprises:
(a) a porous layer of anode material;
(b) a porous layer of cathode material; and
(c) a dense layer of electrolyte material,
wherein one porous layer as defined above forms an internal surface of said tubular solid oxide fuel cell element, and wherein another porous layer as defined above forms an external surface of said tubular solid oxide fuel cell element,
wherein all three materials (a) (b) and (c) completely circumscribe said tubular solid oxide fuel cell element, and
wherein porous layers of anode material of said plurality of tubular solid oxide fuel cell elements are connected at one end to at least one external electrode contact, and wherein porous layers of cathode material of said plurality of tubular solid oxide fuel cell elements are connected at one end to at least one external electrode contact.

37. The power generating device of claim 36, wherein an external surface of one of said plurality of tubular solid oxide fuel cell elements is connected along its length to an external surface of another of said plurality of tubular oxide fuel cell elements, and wherein said connection forms a continuous, common electrode that is shared between the individual tubular solid oxide fuel cell elements.

38. The power generating device of claim 37, wherein said common electrode is connected to one of said external electrode contacts.

39. The power generating device of claim 36, wherein each porous layer that forms the internal surface of said tubular solid oxide fuel cell elements is connected to a hollow tube, wherein said hollow tube serves as one of said external electrode contacts, a flow path to introduce a gas to the interior of said tubular solid oxide fuel cell element, or both.

40. The power generating device of claim 36, further comprising at least one manifold attached to an end of said power generating device, wherein said manifold is capable of being cooled externally.

41. The power generating device of claim 40, wherein said manifold is externally cooled such that said external electrodes are at a temperature that is at least 200° C. lower than the temperature inside said power generating device.

42. The power generating device of claim 40, wherein one manifold is connected to one end of said power generating device, and another manifold is connected to the other end of said power generating device.

43. The power generating device of claim 42, wherein each manifold is cooled independently by radiation, a circulating liquid, a circulating gas, or combinations thereof.

44. The power generating device of claim 36, wherein said external electrode contacts comprise copper, magnesium, manganese, chromium, nickel, aluminum, or alloys or combinations thereof.

45. The power generating device of claim 36, further comprising one or more spines, wherein said spines are internal, external, or internal and external to each of said tubular solid oxide fuel cell elements.

46. The power generating device of claim 45, wherein said spines are dense and internal to each of said tubular solid oxide fuel cell elements.

47. The power generating device of claim 45, wherein said spines are dense and external to each of said tubular solid oxide fuel cell elements.

48. The power generating device of claim 36, wherein at least one of said tubular solid oxide fuel cell elements has a circular, elliptical, oval, hexagonal, square, rectangular, parallelogram, trapezoidal, triangular, or pentagonal cross sectional shape.

49. The power generating device of claim 36, having a temperature of a hot active zone in the interior of said device between about 500 and 1000° C.

50. The power generating device of claim 36, having a temperature of a hot active zone in the interior of said device between about 600 and 800° C.

51. The power generating device of claim 36, having a temperature of said external contacts between about 300 and 800° C.

52. The power generating device of claim 36, wherein said plurality of tubular solid oxide fuel cell elements are bundled together and
(a) share a common external porous electrode bonded to at least one external spine; and
(b) have internal spines equal in number to the number of individual tubular solid oxide fuel cell elements in said bundle,
wherein said plurality of tubular solid oxide fuel cell elements within said bundle are electrically connected in a parallel arrangement.

53. The power generating device of claim 52, wherein said bundle comprises four tubular solid oxide fuel cell elements to form a bundle with either a triangular or square symmetry.

54. The power generating device of claim 52, wherein said bundle comprises six tubular solid oxide fuel cell elements to form a bundle with hexagonal symmetry, wherein said bundle contains one external spine located in the center of the bundle, and wherein said external spine is connected to each of said six tubular solid oxide fuel cell elements.

55. The power generating device of claim 52, wherein said bundle comprises seven tubular solid oxide fuel cell elements to form a bundle with hexagonal symmetry, and wherein said bundle contains at least one external spine located at a junction of three of said tubular solid oxide fuel cell elements.

56. The power generating device of claim 52, wherein said bundle comprises 6 plus 4n tubular solid oxide fuel cell elements, where n is the number of external electrodes, each surrounded by six cells, that protrude from the bundle.

57. The power generating device of claim 52, wherein said individual solid oxide fuel cell elements are bundled into triangular, square, pentagonal, hexagonal, circular, or elliptical shapes or combinations thereof.

58. The power generating device of claim 52, wherein each end of each tubular solid oxide fuel cell element within said bundle has a flow tube that directs gas along said internal surface of said tubular solid oxide fuel cell element, wherein said flow tube contains a seal to prevent a second gas that flows past said external surface from entering the interior of said tubular solid oxide fuel cell element, wherein said seal comprises an electrically compliant material situated between said flow tube and said end of each tubular solid oxide fuel cell element, and wherein said flow tube is held in place by manifolds situated at each end of said bundle.

59. The power generating device of claim 52, further comprising at least one additional bundle of individual solid oxide fuel cell elements,
wherein each of said individual bundles is separated from one another with an insulating material; and
wherein individual bundles are connected to one another by said external spines and said internal spines in a parallel, series, or combination arrangement.

60. A method of generating electrical power using the power generating device of claim 36.
